(19) United States
(12) Patent Application Publication
(10) Pub. No.: US 2025/0192200 A1
(43) Pub. Date: Jun. 12, 2025

(54) AIR-INDEPENDENT PROPULSION FUEL CELL SYSTEM

(71) Applicant: HANWHA AEROSPACE CO., LTD., Changwon-si (KR)

(72) Inventors: Dong Jun SEO, Changwon-si (KR); Dong Jo OH, Changwon-si (KR)

(73) Assignee: HANWHA AEROSPACE CO., LTD., Changwon-si (KR)

(21) Appl. No.: 18/645,720

(22) Filed: Apr. 25, 2024

(30) Foreign Application Priority Data
Dec. 8, 2023 (KR) 10-2023-0177387

(51) Int. Cl. H01M 8/04082; H01M 8/04089; H01M 8/04111; H01M 8/0432; H01M 8/0438; H01M 8/04955; H01M 8/0662; H01M 8/1004; H01M 16/00

(52) U.S. Cl. CPC H01M 8/04197; H01M 8/04097; H01M 8/04111; H01M 8/04201; H01M 8/0432; H01M 8/04373; H01M 8/04388; H01M 8/04955; H01M 8/0662; H01M 8/1004; H01M 16/006; H01M 2250/402

(57) ABSTRACT

A fuel cell system includes a fuel cell including an anode, a cathode, and an electrolyte membrane, where the anode and the cathode face each other across the electrolyte membrane, and where the fuel cell is configured to generate power using a fuel and an oxidizing agent; a first supply path configured to supply the fuel to the anode; a first circulation path configured to supply unreacted fuel from the anode to the first supply path; a second supply path configured to supply the oxidizing agent to the cathode; a second circulation path configured to supply unreacted oxidizing agent from the cathode to the second supply path; and a third path connecting the second circulation path and the first circulation path, the third path configured to supply at least a portion of the unreacted fuel to the second circulation path.

### CROSS-REFERENCE TO RELATED APPLICATION

This application claims priority from Korean Patent Application No. 10-2023-0177387 filed on Dec. 8, 2023, in the Korean Intellectual Property Office, the disclosure of which is incorporated by reference herein in its entirety.

### BACKGROUND

### 1. Field

The present disclosure relates to a fuel cell system operating in an environment where air cannot be supplied, and to a fuel cell system that can resolve the issue of nitrogen cross-over to the anode side in a fuel cell stack supplying air and nitrogen together to the cathode side to simulate actual atmospheric conditions.

### 2. Description of the Related Art

Fuel cell systems are eco-friendly power generation systems that convert hydrogen into electrical energy through an electrochemical reaction with oxygen in the air, possessing high energy densities and eco-friendly characteristics. For this reason, the fuel cell systems are widely utilized in power generation facilities where hydrogen supply is possible, in mobile devices, and in moving devices applying fuel tanks.

Furthermore, fuel cells for submarines or high-altitude aviation, where air supply from the atmosphere is difficult, generate power by reacting oxygen from oxygen tanks with hydrogen from hydrogen tanks, and this is referred to as a so-called air-independent propulsion (AIP) method. When using high concentrations of oxygen and hydrogen together, there are advantages such as increased material diffusion and the ability to generate high currents.

For reference, FIG. 1 shows the performance curves of a fuel cell system for a cases (1) and (2) where air and pure oxygen are supplied, respectively. The performance (output) of the fuel cell system may generally be evaluated by the product of current and voltage, and it can be seen from FIG. 1 that the supply of pure oxygen (2) produces a higher output than the supply of air (1). Especially, the magnitude of the current generated at low voltage is significantly higher with the supply of pure oxygen (2).

On the other hand, as the operating time of fuel cells using high concentrations of oxygen increases, the generation of oxidizing species within membrane electrode assemblies (MEAs) or electrolyte membranes is accelerated, leading to lower durability compared to air-using fuel cells. As a result, fuel cell stacks using pure oxygen, in comparison to air-based fuel cell stacks, employ higher catalyst loadings and thicker electrolyte membranes to prevent rapid performance degradation, which results in higher manufacturing costs.

Therefore, in environments such as submarines, high-altitude aircraft, and space, where air supply from the atmosphere is difficult, fuel cell systems using the AIP method can employ a circulation system that supplies a mixed fluid of nitrogen and oxygen simulating the atmosphere, to address the issue of oxidizing species generation. In this case, a closed-circuit operation occurs, with no external fluid discharge.

Since there is no nitrogen at the cathodes of AIP fuel cells using pure oxygen, nitrogen does not accumulate at the anodes. However, in AIP fuel cells using a mixture of nitrogen and oxygen, since nitrogen crosses over the electrolyte membranes after a prolonged operation, it moves from the cathodes to the anodes and continuously accumulates at the anodes, while circulating in the hydrogen loops. Particularly, the increased concentration of accumulated nitrogen reduces the concentration or partial pressure of hydrogen, leading to a decrease in the performance of the fuel cells.

Therefore, to prevent the accumulation of nitrogen at the anode side, or an increase in nitrogen concentration, it is necessary to periodically purge through a purge valve or store the purged gas in a storage tank.

Moreover, since nitrogen is inert and does not react, its concentration at the cathode side needs to be uniformly maintained. However, as nitrogen crosses over to the anode side, additional nitrogen needs to be supplied to the cathode side, thus requiring an additional system for nitrogen supply in the overall system.

### SUMMARY

Provided is a system which solves the issue in an air-independent propulsion (AIP) fuel cell system using a mixture of nitrogen and oxygen, where the penetration of nitrogen from a cathode to an anode leads to a decrease in nitrogen concentration at the cathode and an increase at the anode.

Further provided is a system for maintaining, in AIP fuel cell systems using a mixture of nitrogen and oxygen, the nitrogen concentration on the sides of a cathode and an anode by recirculating the nitrogen from the anode to the cathode, without the need for supplying additional nitrogen.

Additional aspects will be set forth in part in the description which follows and, in part, will be apparent from the description, or may be learned by practice of the presented embodiments.

According to an aspect of an embodiment, a fuel cell system may include: a fuel cell including an anode, a cathode, and an electrolyte membrane, where the anode and the cathode face each other across the electrolyte membrane, and where the fuel cell is configured to generate power using a fuel and an oxidizing agent; a first supply path configured to supply the fuel to the anode; a first circulation path configured to supply unreacted fuel from the anode to the first supply path; a second supply path configured to supply the oxidizing agent to the cathode; a second circulation path configured to supply unreacted oxidizing agent from the cathode to the second supply path; and a third path connecting the second circulation path and the first circulation path, the third path configured to supply at least a portion of the unreacted fuel to the second circulation path.

The oxidizing agent may include oxygen and nitrogen.

The oxidizing agent may further include a concentration of oxygen in the range of 20% to 90%.

The fuel cell system may further include a first chamber configured to supply the oxidizing agent to the second supply path, where, in a state in which the fuel cell system begins an operation, the first chamber is configured to supply oxygen and nitrogen, and where the first chamber is further configured to supply the oxygen based on the oxygen being reduced by a reaction with the fuel.

The unreacted fuel may include the supplied fuel and at least a portion of the nitrogen from the oxidizing agent that has diffused through the electrolyte membrane to the anode.

The oxidizing agent may further include at least one of argon and helium.

The fuel cell system may further include a pressure pump in the third path configured to pressurize and supply at least a portion of the unreacted fuel to the second circulation path.

The fuel cell system may further include a hydrogen separator in the third path and configured to separate and remove at least a portion of hydrogen from the unreacted fuel.

The fuel cell system may further include a reuse path configured to supply the hydrogen separated by the hydrogen separator to the first circulation path.

The third path may be further configured to supply nitrogen separated by the hydrogen separator to the second circulation path.

The fuel cell system may further include a second chamber configured to store the hydrogen separated by the hydrogen separator.

The hydrogen separator may include an inlet port configured to collect hydrogen in an enclosure; and a fluid processor configured to physically or chemically treat hydrogen included in the unreacted fuel or the hydrogen in the enclosure.

The inlet port may be at an upper portion of the enclosure.

The fuel cell system may further include a controller, where the hydrogen separator further includes a sensor configured to measure a temperature of the hydrogen separator, and where, in a state in which the temperature measured by the sensor exceeds a threshold, the controller is configured to stop an operation of the fuel cell system.

The hydrogen separator may further include a heat exchanger configured to discharge heat generated during a treatment of the hydrogen in the fluid processor.

The fluid processor may be configured to separate at least a portion of the hydrogen from the unreacted fuel using at least one of a membrane exchange method, a physical separation method, or a chemical separation method, where the fluid processor is configured to remove at least a portion of the hydrogen from the unreacted fuel with a platinum-based catalyst.

The fuel cell may further include opposing metal plates configured to support the anode, the cathode, and the electrolyte membrane.

The fuel cell system may further include a power meter to which a current generated in the fuel cell is supplied, where the power meter includes: an inverter connected in parallel to the fuel cell and a battery, where the inverter is configured to convert a direct current (DC) supplied from the fuel cell or the battery into an alternating current (AC) and supply the AC to a power output; a DC-to-DC converter configured to control a generation current and voltage from the fuel cell based on a current demand from a controller; and a sensor configured to measure an output current of the fuel cell during generation and provide the measurement to the controller.

The fuel cell system may further include a first chamber configured to store oxygen and nitrogen, and supply the oxygen and the nitrogen to the second supply path.

The fuel cell system may further include a sensor configured to measure a pressure of the fuel in the first supply path and provide the pressure measurement to a controller; and a sensor configured to measure the temperature within the fuel cell and provide the temperature measurement to the controller.

The fuel cell system may be configured to be an air independent (AIP) fuel cell system.

According to an aspect of an embodiment, a fuel cell system may include: a fuel cell including an anode, a cathode, and an electrolyte membrane, wherein the anode and the cathode face each other across the electrolyte membrane, and the fuel cell is configured to generate power using a fuel and an oxidizing agent; a first supply path configured to supply the fuel to the anode; a first circulation path configured to supply unreacted fuel discharged from the anode to the first supply path; a second supply path configured to supply the oxidizing agent to the cathode, where the oxidizing agent includes oxygen and nitrogen; a second circulation path configured to supply unreacted oxidizing agent discharged from the cathode to the second supply path; a third path configured to supply at least a portion of the unreacted fuel from the first circulation path to the second circulation path; a hydrogen separator in the third path and configured to separate and remove at least a portion of hydrogen from the unreacted fuel; a first chamber configured to supply the oxidizing agent to the second supply path; and a reuse path connecting the hydrogen separator to the first circulation path.

According to an aspect of an embodiment, a method of operating a fuel cell with a fuel and an oxidizing agent, the fuel cell including an anode, a cathode, and an electrolyte membrane, in which the anode and the cathode face each other across the electrolyte membrane, the method includes: supplying fuel to the anode through a first supply path; circulating unreacted fuel from the anode to the first supply path through a first circulation path; supplying oxidizing agent to the cathode through a second supply path; circulating unreacted oxidizing agent from the cathode to the second supply path through a second circulation path; and supplying at least a portion of the unreacted fuel from the second circulation path to a third path which connects the second circulation path and the first circulation path.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram showing the performance curves of a fuel cell system for cases in which air and pure oxygen are supplied, respectively;

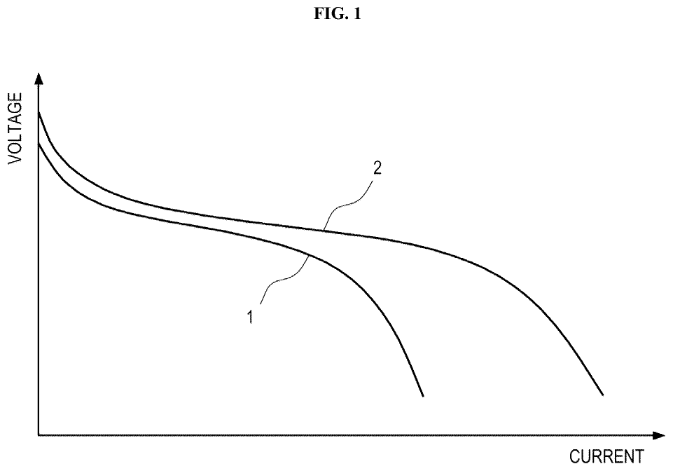

FIG. 2 is a diagram showing decreases in current density according to the nitrogen concentration at an anode outlet;

FIG. 3 is a diagram illustrating the process of maintaining hydrogen concentration and cell voltage above particular levels through hydrogen/nitrogen purging when the cell voltage decreases as the operating time increases;

FIG. 4 is a diagram illustrating the structure of a fuel cell stack according to an embodiment of the present disclosure;

FIG. 5 is a diagram illustrating the configuration of an AIP fuel cell system according to an embodiment of the present disclosure;

FIG. 6 is a diagram illustrating the configuration of an AIP fuel cell system according to another embodiment of the present disclosure; and

FIG. 7 is a diagram illustrating the configuration of a hydrogen separator and controller according to an embodiment of the present disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

Hereinafter, exemplary embodiments of the present disclosure will be described in detail with reference to the accompanying drawings.

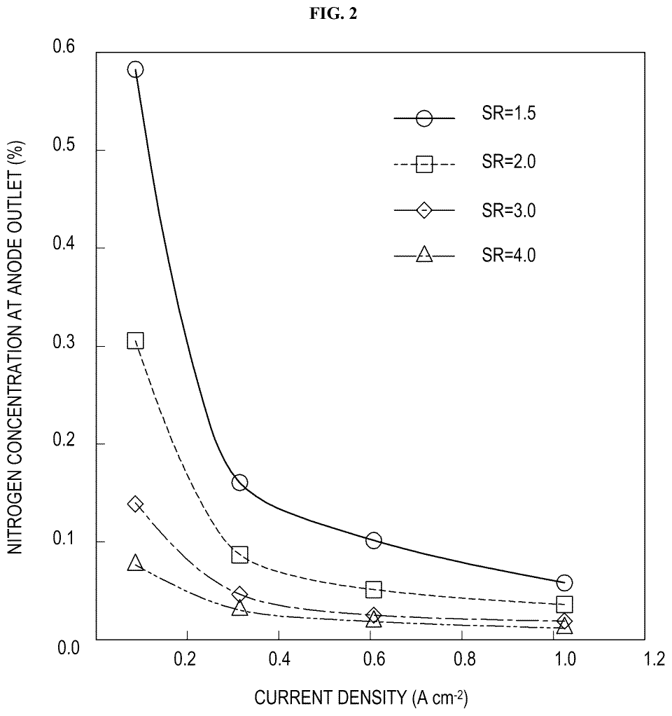

FIG. 2 is a diagram showing decreases in current density according to the nitrogen concentration at an anode outlet. Referring to FIG. 2, the relationship between the nitrogen concentration at the anode outlet and the current density may be understood based on a stoichiometry ratio (SR) value, which represents the ratio of air to a fuel supplied to a fuel cell stack. Regardless of the SR value, an increase in the nitrogen concentration at the anode outlet significantly reduces the current density.

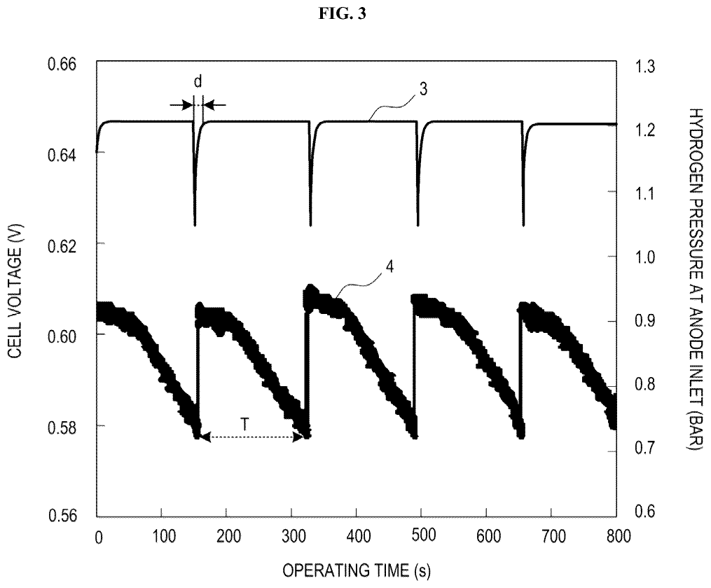

In other words, as the nitrogen concentration at the anode increases, the partial pressure of hydrogen decreases, not only gradually reducing the performance during the operation of the fuel cell stack but also causing irregular hysteresis in the fuel cell stack, as shown in FIG. 3, and can lead to a rapid decline in cell voltage 4. Thus, when the concentration of nitrogen at the anode side increases, it is necessary to perform purging periodically using a purge valve to maintain the concentration of hydrogen.

As shown in FIG. 3, by expelling the fluid from the anode side through the purge valve for a predetermined purge duration d at each predetermined purge cycle T and supplying new hydrogen, a hydrogen pressure or partial pressure 3 at the anode side may increase, and may consequently restore the cell voltage 4.

In this case, however, hydrogen and nitrogen may be expelled externally, which poses risks depending on the operating environment, and there may be a limitation that a long-term operation is only possible if maintaining an additional nitrogen supply to the cathode is continued.

Therefore, one or more embodiments describe an AIP fuel cell system, which may maintain the concentration of hydrogen (H₂) at an anode side by purging (or recirculating) nitrogen (N₂) from the anode side to a cathode side and may sustain a continuously operable environment without the need for additional components to maintain the concentration of N₂ at the cathode side.

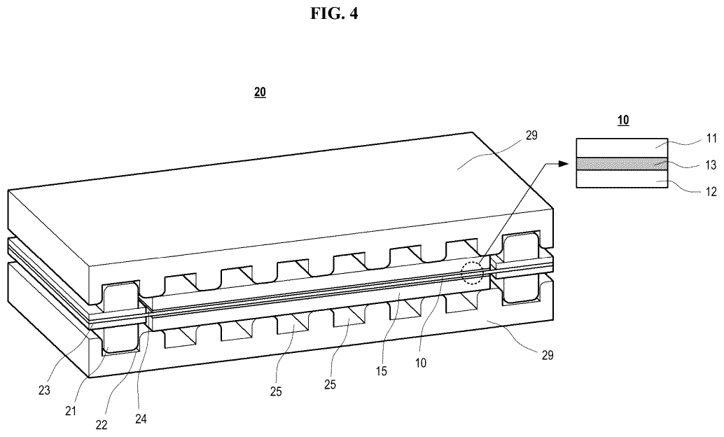

FIG. 4 is a diagram illustrating the structure of a fuel cell stack 20 according to an embodiment of the present disclosure.

Referring to FIG. 4, for example, the fuel cell stack 20 may include a membrane electrode assembly (MEA) 10, which consists of a stack of a cathode 11, an anode 12, and an electrolyte membrane 13, a gas diffusion layer 15, a plurality of flow channels 25, gaskets (21 and 23), a hermetic channel 22, and an MEA-gasket junction 24. These components may be held and supported between opposing metal separator plates or bi-polar plates (BPPs) 29.

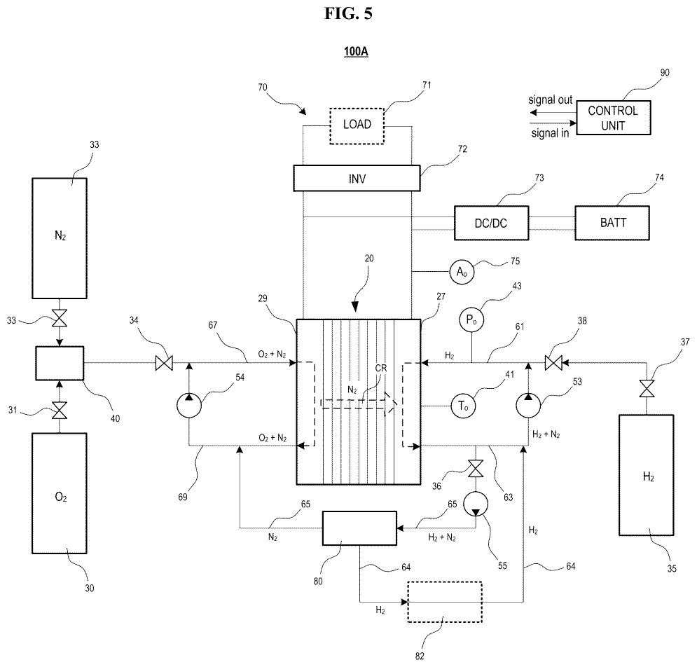

FIG. 5 is a diagram illustrating the configuration of an AIP fuel cell system 100A according to an embodiment of the present disclosure.

Referring to FIG. 5, a fuel cell stack 20, which is a core component for power generation using a fuel (H₂) and an oxidizing agent (O₂+N₂), may include an anode 27 and a cathode 29 arranged to face each other across an electrolyte membrane.

Additionally, the hydrogen used as the fuel (H₂) may be stored in a fuel tank 35, and the oxygen and nitrogen of the oxidizing agent (O₂+N₂) may be stored in an oxygen tank 30 and a nitrogen tank 33, respectively. In the following, the oxidizing agent will be described as including oxygen and nitrogen. However, this is merely an example, and other inert gases such as argon, helium, etc., may be added in addition to or instead of nitrogen.

Firstly, O₂ is may be from the oxygen tank 30 through an oxygen valve 31 to a first chamber 40, and N₂ may be supplied from the nitrogen tank 33 through a nitrogen valve 33 to the first chamber 40. The first chamber 40 may temporarily store a mixed fluid (O₂+N₂) and then may supply the mixed fluid (O₂+N₂) to an oxidant supply path 67 through a supply valve 34 under the control of a controller 90. Although N₂ and O₂ account for about 79% and 20%, respectively, of the atmosphere, the mixed fluid (O₂+N₂) may not need to maintain the same ratios of O₂ and N₂ therein. For example, the concentration of O₂ in the mixed fluid may range from 20-90%.

If the concentration of N₂ in the mixed fluid (O₂+N₂), circulating at the cathode 29, can be maintained almost uniformly, a continuous supply of N₂ may be unnecessary. Therefore, the first chamber 40 may only need to supply the mixed fluid (O₂+N₂) once at the startup of the AIP fuel cell system 100A, and later on, may only replenish the amount of O₂ reduced by the reaction with the fuel (H₂).

Hydrogen (H₂) may be supplied from the fuel tank 35 through a hydrogen valve 37 and a supply valve 38 to a fuel supply path 61.

Through this process, the fuel (H₂) may be supplied to the anode 27 of the fuel cell stack 20 through the fuel supply path 61, and the oxidizing agent (O₂+N₂) may be supplied to the cathode 29 of the fuel cell stack 20 through the oxidant supply path 67. Within the fuel cell stack 20, the reaction of the fuel (H₂) with O₂ may produce water (H₂O) and may generate current, which may be supplied to the power meter 70.

The power meter 70 may include an inverter 72, a direct current-to-direct current (DC-to-DC) converter 73, a battery 74, and a current sensor 75. The inverter 72 may be connected in parallel to the fuel cell stack 20 and the battery 74 and may convert the DC supplied from either the fuel cell stack 20 or the battery 74 into an alternating current (AC) to supply the AC to the power output 71. The DC-to-DC converter 73 may increase the output voltage of the battery 74 to supply the inverter 72, and may reduce the output voltage to charge the battery 74 with surplus power generated by the fuel cell stack 20.

The DC-to-DC converter 73 may control a generation current and voltage of the fuel cell stack 20 based on the current demand received from the controller 90. Additionally, the current sensor 75 may measure an output current Aₒ of the fuel cell stack 20 during generation and may transmit the output current Aₒ to the controller 90. Similarly, a pressure sensor 43 may measure a pressure Pₒ of the fuel (H₂) in the fuel cell supply path 61 and may transmit the pressure Pₒ to the controller 90, and a temperature sensor 41 may measure an internal temperature Tₒ of the fuel cell stack 20 and may transmit the internal temperature Tₒ to the controller 90.

During the process in which water is produced and current is generated from the reaction of the fuel (H₂) with O₂ within the fuel cell stack 20, N₂, which does not participate in the corresponding reaction, may move to the anode 27 through the minute pores of the electrolyte membrane due to a concentration difference between the cathode 29 and the anode 27. This phenomenon is referred to as fluid crossover CR. Consequently, a certain amount of N₂ may be found at the anode 27, which otherwise may solely receive and circulate the pure fuel (H₂).

According to an embodiment, referring to FIG. 5, the fuel cell stack 20 may enhance the recyclability of fluids by recirculating the fuel (H₂) and the oxidizing agent (O₂+N₂) supplied thereto through the fuel supply path 61 and the oxidant supply path 67, respectively. An unreacted fuel (H₂+N₂) discharged from the anode 27 may be recirculated to the fuel supply path 61 through a fuel circulation path 63, and an unreacted oxidizing agent (O₂+N₂) discharged from the cathode 29 may be recirculated to the oxidant supply path 67 through an oxidant circulation path 69. Most of the unreacted oxidizing agent (O₂+N₂) from the cathode 29 may include N₂ with a small amount (e.g., 0% to 50%) of O₂ being present. Here, N₂ may be reused and may not need to be continuously supplied, but the oxygen (O₂) reduced in the reaction of the fuel (H₂) with O₂ may need to be replenished from the oxygen tank 30.

Furthermore, to facilitate the recirculation of fluids, pressure pumps 53 and 54 may be installed in the fuel circulation path 63 and the oxidant circulation path 69, respectively.

However, during the repeated recirculation of the fluids from the cathode 29 and the anode 27, due to the fluid crossover CR, the concentration of N₂ at the cathode 29 may gradually decrease, while the concentration of N₂ at the anode 27 may gradually increase. This phenomenon may induce the need to replenish N₂ at the cathode 29 and to remove N₂ at the anode 27.

In consideration of these and other issues, the AIP fuel cell system 100A may further include a purge path 65, which may connect the fuel circulation path 63 and the oxidant circulation path 69. The purge path 65 may be connected to the oxidant circulation path 69 by branching off from one point in the fuel circulation path 63, and may function to supply at least a portion of the unreacted fuel (H₂+N₂) to the oxidant circulation path 69. Here, the oxidizing agent (O₂+N₂) may include O₂ and N₂, and the unreacted fuel (H₂+N₂) may include the supplied fuel (H₂) and a portion of N₂ from the oxidizing agent (O₂+N₂) that has permeated through the electrolyte membrane to the anode 27.

A pressure pump 55 and/or a valve 36 may be installed in the middle of the purge path 65 to facilitate the smooth supply (or reuse) of at least some of the unreacted fuel (H₂+N₂) to the oxidant circulation path 69. However, as the reuse through the purge path 65 may not always be necessary, the controller 90 may enable a reuse process through the purge path 65 by opening the valve 36 to operate the pressure pump 55 in a state in which the partial pressure (or concentration) of N₂ relative to H₂ within the fuel circulation path 63 exceeds a predetermined threshold. This reuse process may be performed intermittently or periodically and may be carried out without stopping the operation of the AIP fuel cell system 100A.

Along with, or separately from, the operation of the pressure pump 55, the pressure pump 51, which pressurizes and supplies the hydrogen from the fuel tank 35 to the fuel supply path 61, may also be operated to temporarily increase the supply pressure of H₂.

As the unreacted fuel (H₂+N₂) may be supplied to the oxidant circulation path 69 through the pressure pump 55, recirculated nitrogen (N₂) may be reused. However, there may be unreacted hydrogen (H₂) present at the cathode 29, and the unreacted hydrogen may react with O₂ in the presence of a catalyst such as platinum (Pt), cobalt (Co), etc., producing a small amount of H₂O as a side effect. However, as long as the concentration of the unreacted hydrogen does not exceed a threshold, the overall efficiency of the AIP fuel cell system 100A may not be significantly affected.

The removal of such minute amounts of unreacted hydrogen may contribute further to the overall reaction efficiency. Therefore, in the middle of the purge path 65, downstream of the pressure pump 55 in the purge path 65, a hydrogen separator 80 may be installed to extract and separate at least a portion of the hydrogen from the unreacted fuel (H₂+N₂). The hydrogen separator 80 may separate hydrogen from the unreacted fuel (H₂+N₂) using a method such as membrane exchange, physical separation, or chemical separation. Alternatively, the hydrogen separator 80 may also remove H₂ from the unreacted fuel (H₂+N₂). Various techniques using Pt-based catalysts to remove hydrogen at room temperature (e.g., KR 2013-0082272A, KR 2016-0073797A, etc.) are known for this type of removal method.

The nitrogen (N₂) remaining after the separation/removal of H₂ in the hydrogen separator 80 (which may contain 0-4% of H₂, preferably less than 0.5% of H₂) may be resupplied to the oxidant circulation path 69 through the purge path 65. Moreover, the separated hydrogen (H₂) from the hydrogen separator 80 may be stored in a storage tank 82, or may be supplied back to the fuel circulation path 63 through a separate hydrogen reuse path 64.

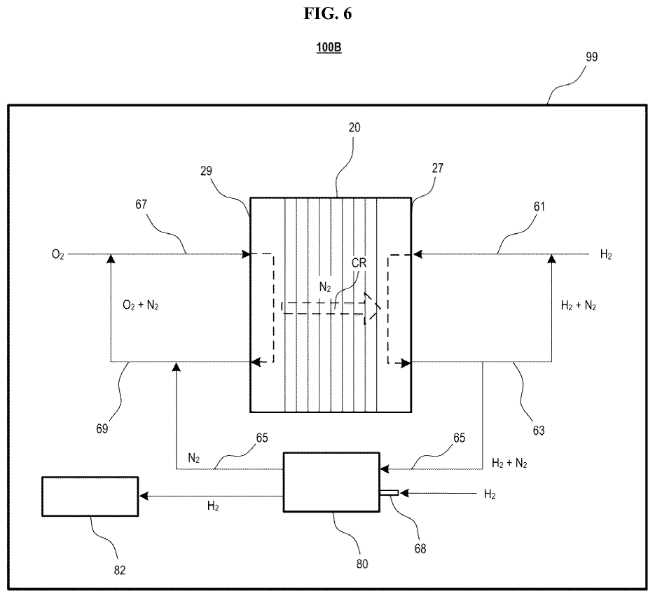

FIG. 6 illustrates the configuration of an AIP fuel cell system 100B according to an embodiment of the present disclosure. Referring to FIG. 6, an AIP fuel system 100B may include a fail-safe feature.

Referring to FIG. 6, the AIP fuel cell system 100B may be housed in an enclosed space 99. The enclosed space 99 may prevent accidents caused by leaks from any part of the AIP fuel cell system 100B. However, such leaked fluids (especially H₂) accumulated above a certain concentration in the enclosed space 99 may also be a dangerous situation.

Accordingly, a hydrogen separator 80 installed in the AIP fuel cell system 100B may include an inlet port 68, which is for collecting H₂ present in the enclosed space 100 due to leaks from a fuel cell stack 20 or some of a plurality of paths (61, 63, 64, 65, 67, and 69), acting as an emergency purification National. Given the lightweight nature of H₂, the inlet port 68 may be located at an upper part of the enclosed space 99.

Therefore, the hydrogen separator 80 may extract and separate the hydrogen (H₂) introduced through the inlet port 68 and the hydrogen (H₂) from an unreacted fuel (H₂+N₂) discharged from an anode 27. The separated hydrogen (H₂) may be stored in a separate storage tank 82. The nitrogen (N₂) remaining after the separation of the hydrogen may be recirculated to an oxidant circulation path 69, and the separated hydrogen (H₂) may be recirculated to a fuel circulation path 63.

Additionally, if the flow rate of the hydrogen introduced through the inlet port 68 exceeds a predetermined threshold, a controller 90 may store the hydrogen in the storage tank 82 and may even stop the operation of the AIP fuel cell system 100B.

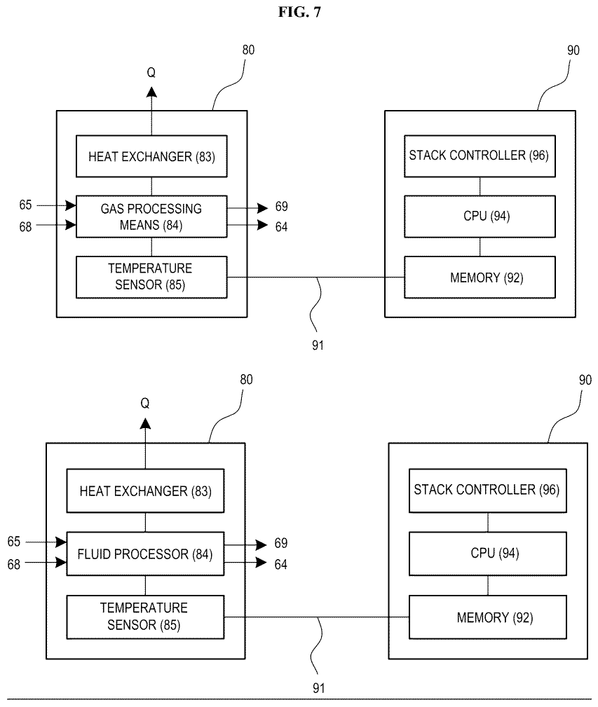

FIG. 7 illustrates an embodiment of a hydrogen separator 80 and a controller 90. Referring to FIG. 7, the hydrogen separator 80 may include a fluid processor 84 and a temperature sensor 85 and may further include a heat exchanger 83.

The fluid processor 84 may separate or remove the hydrogen introduced through a purge path 65 or an inlet port 68 through a membrane exchange method, a physical separation method, or a chemical separation method, and may be removed with a platinum-based catalyst. Hydrogen (H₂) separated through the fluid processor 84 may be supplied to a reuse path 64 or a storage tank 82, and the remaining nitrogen (N₂) from the separation may be supplied to an oxidant circulation path 69.

The temperature sensor 85 may measure the temperature of the hydrogen separator 80 and may provide the result of the measurement to the controller 90.

The heat exchanger 83 may discharge heat Q generated during the treatment of H₂ in the fluid processor 84 to the outside. For example, the heat Q may be generated by an exothermic chemical reaction between H₂ and the fluid processor 84. The heat Q may be used for heating or other purposes within a device equipped with an AIP fuel cell system.

The controller 90 may be connected to the hydrogen separator 80 via a communication bus 91 and may include a central processing unit (CPU) 94, a memory 92, and a stack controller 96. The CPU 94 may control the operations of the other components of the controller 90. The memory 92 may receive data or signals from the other components connected via the communication bus 91 and may store results of the operation of the CPU 94 or data required for the operation of the CPU 94. The memory 92 may be implemented as a volatile or nonvolatile memory. The stack controller 96 may perform a fail-safe operation to stop the operation of the AIP fuel cell system if the temperature measured by the temperature sensor 85 exceeds a threshold. This fail-safe feature may be applied to environments where it is difficult or costly to install expensive real-time hydrogen concentration meters or where cost reduction is necessary.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

1. A fuel cell system comprising:
a fuel cell comprising an anode, a cathode, and an electrolyte membrane, wherein the anode and the cathode face each other across the electrolyte membrane, and the fuel cell is configured to generate power using a fuel and an oxidizing agent;
a first supply path configured to supply the fuel to the anode;
a first circulation path configured to supply unreacted fuel from the anode to the first supply path;
a second supply path configured to supply the oxidizing agent to the cathode;
a second circulation path configured to supply unreacted oxidizing agent from the cathode to the second supply path; and
a third path connecting the second circulation path and the first circulation path, the third path configured to supply at least a portion of the unreacted fuel to the second circulation path.

2. The fuel cell system of claim 1, wherein the oxidizing agent comprises oxygen and nitrogen.

3. (canceled)

4. The fuel cell system of claim 2, further comprising a first chamber configured to supply the oxidizing agent to the second supply path,
wherein, in a state in which the fuel cell system begins an operation, the first chamber is configured to supply the oxygen and the nitrogen to the second supply path, and
wherein the first chamber is further configured to supply the oxygen based on the oxygen being reduced by a reaction with the fuel.

5. (canceled)

6. (canceled)

7. The fuel cell system of claim 1, further comprising a pressure pump in the third path configured to pressurize and supply at least a portion of the unreacted fuel to the second circulation path.

8. The fuel cell system of claim 1, further comprising a hydrogen separator in the third path and configured to separate and remove at least a portion of hydrogen from the unreacted fuel.

9. The fuel cell system of claim 8, further comprising a reuse path configured to supply the hydrogen separated by the hydrogen separator to the first circulation path.

10. The fuel cell system of claim 9, wherein the third path is further configured to supply nitrogen separated by the hydrogen separator to the second circulation path.

11. The fuel cell system of claim 8, further comprising a second chamber configured to store the hydrogen separated by the hydrogen separator.

12. The fuel cell system of claim 8, wherein the hydrogen separator comprises:
an inlet port configured to collect hydrogen in an enclosure; and
a fluid processor configured to physically or chemically treat hydrogen included in the unreacted fuel or the hydrogen in the enclosure.

13. The fuel cell system of claim 12, wherein the inlet port is at an upper portion of the enclosure.

14. The fuel cell system of claim 12, further comprising a controller,
wherein the hydrogen separator further comprises a sensor configured to measure a temperature of the hydrogen separator, and
wherein, in a state in which the temperature measured by the sensor exceeds a threshold, the controller is configured to stop an operation of the fuel cell system.

15. The fuel cell system of claim 14, wherein the hydrogen separator further comprises a heat exchanger configured to discharge heat generated during a treatment of the hydrogen in the fluid processor.

16. The fuel cell system of claim 12, wherein the fluid processor is configured to separate at least a portion of the hydrogen from the unreacted fuel using at least one of a membrane exchange method, a physical separation method, or a chemical separation method, and
wherein the fluid processor is configured to remove at least a portion of the hydrogen from the unreacted fuel with a platinum-based catalyst.

17. The fuel cell system of claim 1, wherein the fuel cell further comprises opposing metal plates configured to support the anode, the cathode, and the electrolyte membrane.

18. The fuel cell system of claim 1, further comprising a power meter to which a current generated in the fuel cell is supplied,
wherein the power meter comprises:
an inverter connected in parallel to the fuel cell and a battery, wherein the inverter is configured to convert a direct current (DC) supplied from the fuel cell or the battery into an alternating current (AC) and supply the AC to a power output;
a DC-to-DC converter configured to control a generation current and voltage from the fuel cell based on a current demand from a controller; and
a sensor configured to measure an output current of the fuel cell during generation and provide the measurement to the controller.

19. The fuel cell system of claim 1, further comprising a first chamber configured to store oxygen and nitrogen, and supply the oxygen and the nitrogen to the second supply path.

20. The fuel cell system of claim 1, further comprising:
a sensor configured to measure a pressure of the fuel in the first supply path and provide the pressure measurement to a controller; and
a sensor configured to measure a temperature within the fuel cell and provide the temperature measurement to the controller.

21. The fuel cell system of claim 1, further configured to be an air independent (AIP) fuel cell system.

22. A fuel cell system comprising:
a fuel cell comprising an anode, a cathode, and an electrolyte membrane, wherein the anode and the cathode face each other across the electrolyte membrane, and the fuel cell is configured to generate power using a fuel and an oxidizing agent;
a first supply path configured to supply the fuel to the anode;
a first circulation path configured to supply unreacted fuel discharged from the anode to the first supply path;
a second supply path configured to supply the oxidizing agent to the cathode, wherein the oxidizing agent comprises oxygen and nitrogen;
a second circulation path configured to supply unreacted oxidizing agent discharged from the cathode to the second supply path;
a third path configured to supply at least a portion of the unreacted fuel from the first circulation path to the second circulation path; a hydrogen separator in the third path and configured to separate and remove at least a portion of hydrogen from the unreacted fuel;
a first chamber configured to supply the oxidizing agent to the second supply path; and
a reuse path connecting the hydrogen separator to the first circulation path.

23. A method of operating a fuel cell system with a fuel cell including an anode, a cathode, and an electrolyte membrane, in which the anode and the cathode face each other across the electrolyte membrane, the method comprises:
supplying a fuel to the anode through a first supply path;
circulating unreacted fuel from the anode to the first supply path through a first circulation path;
supplying an oxidizing agent to the cathode through a second supply path;
circulating unreacted oxidizing agent from the cathode to the second supply path through a second circulation path; and
supplying at least a portion of the unreacted fuel from the second circulation path to a third path which connects the second circulation path and the first circulation path.
